(19) United States
(12) Patent Application Publication
(10) Pub. No.: US 2017/0082121 A1
(43) Pub. Date: Mar. 23, 2017

(54) Valve Manifold with Breather Protection

(71) Applicant: Caterpillar Global Mining America LLC, Houston, PA (US)

(72) Inventor: Kevin D. Kolonsky, Scenery Hill, PA (US)

(73) Assignee: Caterpillar Global Mining America LLC, Houston, PA (US)

(21) Appl. No.: 14/858,565

(22) Filed: Sep. 18, 2015

(51) Int. Cl. F15B 13/02; F15B 21/00; F15B 1/26

(52) U.S. Cl. CPC F15B 13/027; F15B 1/26; F15B 21/006; F15B 2201/40

(57) ABSTRACT

A valve manifold for a fluid tank is disclosed, as well as methods for fluid circulation between a valve manifold and a fluid tank. The valve manifold and methods may include a breather that is configured to receive atmospheric air. The valve manifold and methods may also include a first check valve that is in fluid communication with a breather and that is configured to allow fluid intake into the valve manifold. The valve manifold and methods may further include a second check valve configured to allow fluid exhaust out of the valve manifold.

### TECHNICAL FIELD

The present disclosure generally relates to a hydraulic system for a machine and, more particularly, relates to a valve manifold having a breather and in fluid communication with a hydraulic fluid tank.

### BACKGROUND

Machines such as continuous miners, feeder breakers, roof bolters, utility vehicles for mining, load haul dump vehicles, scoops, underground mining loaders, underground articulated trucks, dozers, excavators, motor graders and other types of heavy machinery or systems use one or more hydraulic actuators to accomplish a variety of tasks. These actuators are fluidly connected to a hydraulic fluid tank mounted on the machine and, using pumps, pressurized fluid is provided to chambers within the actuators. Valve arrangements are fluidly connected between the tank and the actuators to control a flow rate and direction of pressurized fluid flow to and from the chambers of the actuators. Thus, the fluid from the tank is continuously provided to the actuators, and the fluid follows in a closed hydraulic circuit and is fed back to the tank.

In order to accommodate volumetric changes of hydraulic fluid within the tank, the tank may include a breather that allows for air flow into and out of the tank due to pressure changes therein. Breather systems are commonly employed in both hydraulic systems and in internal combustion engines. Typically, in a hydraulic system, the breather is bidirectional and attached to a top of the hydraulic fluid tank. Breathers often contain a filter element and function by drawing in and exhausting air to regulate pressure within the fluid tank. The filter element of the breather cleanses the air entering the fluid tank. Therefore, when air is drawn in through the breather, the breather serves as a pathway for air to enter the fluid tank without also transmitting accompanying pollutants found in the environment into the tank. When air is exhausted through the breather, the breather discharges air and filtered particles dislodged from the filter element of the breather into the environment while maintaining the tank at a desired pressure.

With time and use, or due to leakage in the hydraulic circuit, the hydraulic fluid in the hydraulic fluid tank requires refilling. Conventionally, a mining machine employs a venturi-type apparatus to fill the hydraulic fluid tank. The venturi-type design may not include any automatic stop system associated with the filling of the tank, due to which, the tank may be overfilled. This overfilling of the tank may result in the hydraulic fluid exiting through a breather system associated with the tank. Contamination of the breather system with the hydraulic fluid may accelerate wear of the breather, reduce its durability, cause clogging or ruin the breather completely. Specifically, hydraulic fluid within the breather can contaminate any filter material and coat the surface and internal pathways of the breather, as well as the surrounding surface of the fluid tank. This coating can attract dust, dirt and other pollutants, which can accumulate in the internal pathways of the breather and block the passage of air into and out of the fluid tank. This can undermine the breather's ability to maintain the fluid tank at a desired pressure, which may result in structural damage to the tank.

One attempt to control the contamination of a breather is disclosed in U.S. Patent Application Publication No. US 2014/0151384 (the '384 publication), published on Jun. 5, 2014, and submitted by Kulack et al. The '384 publication discloses a splash guard for use with a breather of a hydraulic tank. Specifically, a splash guard mounted within the interior of the tank limits exposure of the breather system to hydraulic fluid churning and splashing within the tank, while maintaining a channel for air flow into and out of the tank through the breather. Although the breather configuration disclosed in the '384 publication helps to control inadvertent contamination of the breather by hydraulic oil within the tank, the breather of the '384 publication may still be subject to contamination where overfilling of the tank occurs and pressurized fluid is directed through the breather. Accordingly, it would be beneficial to provide a system that isolates the breather entirely from any hydraulic fluid exposure, whether by splashing or overfilling, thereby avoiding the above-described inefficiencies and damage to the breather system, as well as hydraulic fluid loss.

### SUMMARY

In accordance with one aspect of the present disclosure, a valve manifold for a fluid tank is disclosed which may include a breather configured to receive atmospheric air. The valve manifold may further include a first check valve in fluid communication with the breather and configured to allow fluid intake into the valve manifold. In addition, the valve manifold may include a second check valve configured to allow fluid exhaust out of the valve manifold.

In accordance with another aspect of the present disclosure, a hydraulic system including a hydraulic fluid tank is disclosed. The hydraulic system may further include an actuator in fluid communication with the tank and configured to receive pressurized hydraulic fluid from the tank. In addition, the hydraulic system may include a valve manifold in fluid communication with the tank. The valve manifold of the disclosed hydraulic system may include a breather in fluid communication with a first check valve, the first check valve being configured to allow fluid intake into the hydraulic system. In addition, the valve manifold may include a second check valve, the second check valve being configured to allow fluid exhaust out of the hydraulic system.

In accordance with another aspect of the present disclosure, a method of circulating fluid in a hydraulic system is disclosed which may include providing a hydraulic fluid tank and a valve manifold in fluid communication with the tank, the valve manifold including a breather. The method may further include intaking the fluid into the hydraulic system by passage of the intake fluid from the breather, through a first check valve in the valve manifold and into the tank. In addition, the method may include exhausting fluid from the hydraulic system by passage of the exhaust fluid from the tank, through a second check valve in the valve manifold and out of the valve manifold.

These and other aspects and features of the present disclosure will be better understood when read in conjunction with the accompanying drawings.

### BRIEF DESCRIPTION OF THE DRAWINGS

FIG. 1 is a perspective top view of an exemplary mining machine.

FIG. 2 is a schematic diagram of an exemplary hydraulic system that may be used in conjunction with the machine of FIG. 1.

FIG. 3 is a perspective view of an exemplary valve manifold and conduits that may be used in conjunction with the hydraulic system of FIG. 2.

FIG. 4 is a perspective view of an exemplary valve manifold.

FIG. 5 illustrates fluid flow paths through conduits and valves of an exemplary valve manifold.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

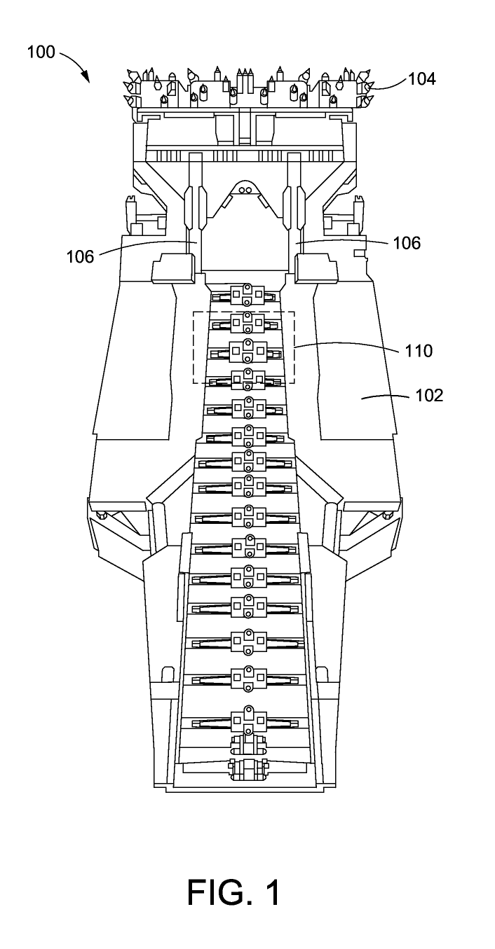

FIG. 1 illustrates an exemplary machine 100, in this case, a continuous miner. Alternatively, the machine 100 may be a fixed or mobile machine that performs operations associated with an industry such as mining, construction, farming or any other industry known in the art. For example, the machine 100 may be an earth moving machine such as a miner, dozer, a loader, a backhoe, an excavator, a motor grader, a dump truck or any other earth moving machine. Likewise, the machine 100 may be one of many underground mining machines, for example, a feeder breaker, a roof bolter, a utility vehicle for mining, a load haul dump vehicle, a scoop, an underground mining loader, an underground articulated truck or another type of heavy machinery or system used in underground mining. The machine 100 may also embody a generator set, a pump, a marine vessel or any other suitable machine.

The machine 100 includes a frame 102, at least one implement 104 and at least one hydraulic actuator 106 between the implement 104 and the frame 102. The implement 104 is illustrated as a mining tooth. Alternatively, the implement 104 may include any other work tool used for the performance of a task by the respective machine. For example, the implement 104 may be a blade, a bucket, a shovel, a ripper, a dump bed, a propelling device or any other task-performing device known in the art. The implement 104 rotates and moves relative to the frame 102.

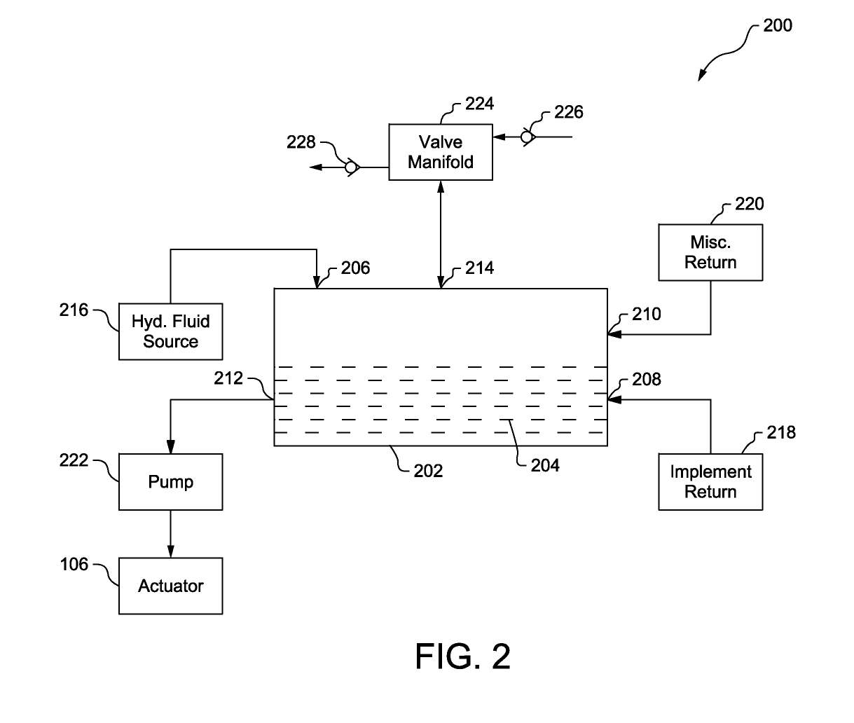

The frame 102 may be a stationary base frame connecting a power source of the machine 100 to a traction device, a moveable frame member of a linkage system or any other frame known in the art. The hydraulic actuator 106 present on the machine 100 is a hydraulically operated component that is operable on provision of hydraulic fluid under pressure. Such hydraulic fluid may be provided to the hydraulic actuator 106 from a tank 202 (see FIG. 2) present on the machine 100. In an example, the tank 202 may be positioned proximate to an area 110 as labeled on the machine 100 of FIG. 1.

FIG. 2 illustrates a hydraulic system 200 that may be used in conjunction with the machine 100. The hydraulic system 200 includes the tank 202. The tank 202 illustrated is configured to store hydraulic fluid 204. Alternatively, the tank 202 may serve as a reservoir for an engine lubrication oil, a transmission lubrication oil, a fuel or any other fluid known in the art. The tank 202 may be a cuboidal shape or any other geometrical shape. The hydraulic tank 202 includes multiple fluid inlets and outlets as schematically illustrated in FIG. 2. The inlets and outlets of the tank 202 may include spouts on the interior or exterior of the tank 202 that are connected with hoses, pipes or other fluid conduits known in the art. For example, the hydraulic tank 202 may have first, second and third fluid inlets 206, 208 and 210, as well as fluid outlet 212 and inlet/outlet port 214. While the hydraulic tank 202 is shown having three inlets, one outlet and one inlet/outlet port, it will be appreciated that the tank 202 may have different numbers of inlets, outlets and ports.

The first fluid inlet 206 may communicate with a hydraulic fluid source 216. The hydraulic fluid source 216 may be any mobile or immobile source for supplying the fluid 204 to the tank 202 through a supply line. The supply line between the hydraulic fluid source 216 and the tank 202 may be a hose associated with a venturi-type apparatus or pump on the machine 100. The second fluid inlet 208 may communicate with an implement return line 218, which returns hydraulic fluid 204 from hydraulic components used to operate the implement 104 provided on the machine 100. The third fluid inlet 210 may communicate with a miscellaneous return line 220, which returns fluid 204 from one or more other hydraulic components provided on the machine 100. The fluid outlet 212 may communicate with the hydraulic actuator 106 for operation of the hydraulic actuator 106. For example, the fluid 204 may be transferred at an elevated pressure to the hydraulic actuator 106 via a hydraulic pump 222. The hydraulic pump 222 may be any type of known positive displacement pumps. Alternatively, the hydraulic pump 222 may be any other component serving the purpose of supplying the fluid 204 from the tank 202 to different components of the machine 100.

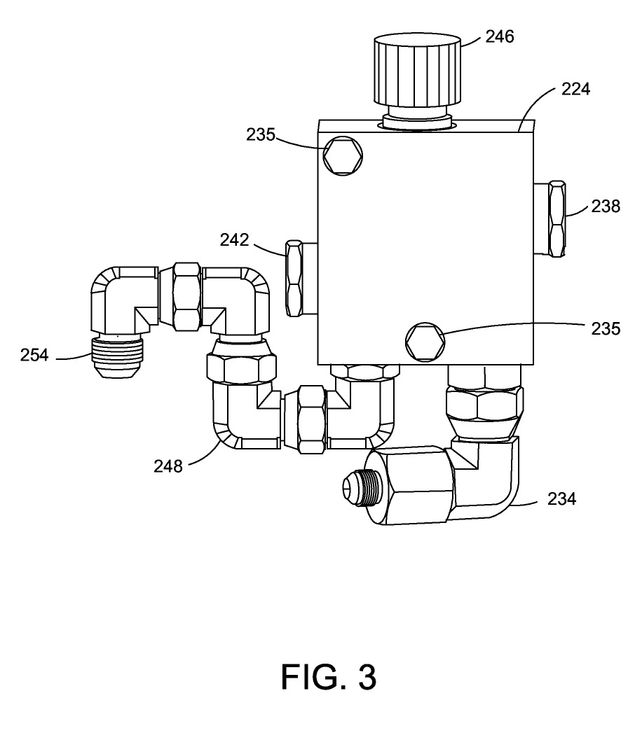

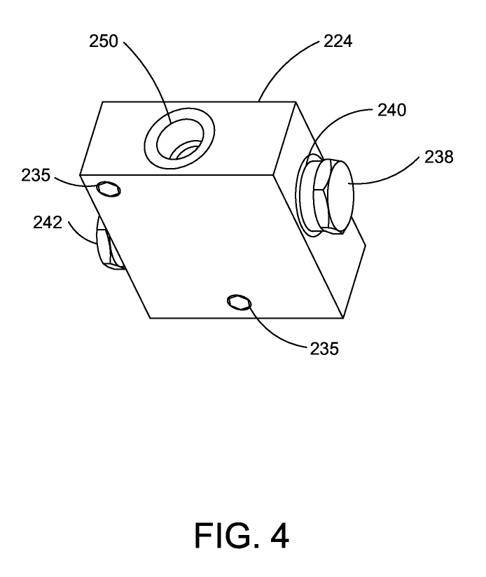

The inlet/outlet port 214 of the hydraulic tank 202 may communicate bidirectionally with a valve manifold 224. The valve manifold includes a first check valve 226 that provides for fluid intake into the valve manifold 224, and a second check valve 228 that provides for fluid exhaust out of the valve manifold 224. FIGS. 3, 4 and 5 illustrate an exemplary valve manifold 224, in this case, having a cuboidal shape. It will be appreciated that the valve manifold 224 may have any number of geometrical shapes common in the art. Additionally, the valve manifold 224 may be fabricated from any suitable materials known in the art, including, for example, from a metallic material or a polymer material. In the disclosed embodiments, the valve manifold 224 is fabricated from steel. Fluid communication between the inlet/outlet port 214 of the tank 202 and the valve manifold 224 may be through a fluid conduit 234, which may be a hose, a pipe or any other fluid conduit known in the art. In the disclosed embodiments, the fluid conduit 234 is fabricated from steel. The fluid conduit 234 may be received by or otherwise engaged with a first port 236 of the valve manifold 224. The engagement between the fluid conduit 234 and the valve manifold 224 may comprise a threaded arrangement, a friction fit or any other known attachment means. As such, the fluid conduit 234 may allow for fluid movement, whether hydraulic fluid 204, air or both, between the tank 202 and the valve manifold 224.

Mounting bolts 235, or any attachment mechanism common in the art, may be employed for securing the valve manifold 224 to the machine frame 102 or any other component integral with the machine 100 or the hydraulic system 200. While the valve manifold 224 is illustrated as separate but connected to the hydraulic tank 202, it will be appreciated that the manifold 224 may alternatively be mounted directly to the tank 202, so long as the tank 202 and the valve manifold 224 remain in fluid communication. In this manner, both air and hydraulic fluid 204 may enter or exit the inlet/outlet port 214 and, accordingly, enter or exit the valve manifold 224. Additionally, the inlet/outlet port 214 may be disposed at different locations on the tank 202. While FIG. 2 schematically represents the inlet/outlet port 214 at the top of the tank 202, the inlet/outlet port 214 may be disposed at a gravitationally lower location on the tank 202. Such an arrangement may allow for the hydraulic fluid 204 to exit from the tank 202 while maintaining a volume of air within the tank 202, which may positively influence the efficiency of the hydraulic system 200.

The first and second check valves 226, 228 of the valve manifold 224 allow for one-way fluid flow into or out of the valve manifold 224. Specifically, the first check valve 226 allows for air flow into the valve manifold 224 and ultimately into the tank 202 while preventing any reverse fluid flow out of the valve manifold 224 through the check valve 226. The second check valve 228 allows for hydraulic fluid or air flow out of the tank 202 and the valve manifold 224. Specifically, hydraulic fluid 204 or air may be delivered from the tank 202 to the valve manifold 224 via the fluid conduit 234. Thereafter, the fluid may exit the valve manifold 224 through the check valve 228, which also prevents any fluid flow into the valve manifold 224 and the tank 202 through the check valve 228. The check valves 226, 228 may be any types of check valves known in the art including, for example, a ball check valve, a diaphragm check valve, a swing check valve, a tilting disc check valve, a stop-check valve, an in-line check valve, a duckbill check valve, a poppet check valve or a spool check valve. The type of check valve employed in the valve manifold 224 may depend on the target pressure sought within the hydraulic tank 202 or the hydraulic system 200.

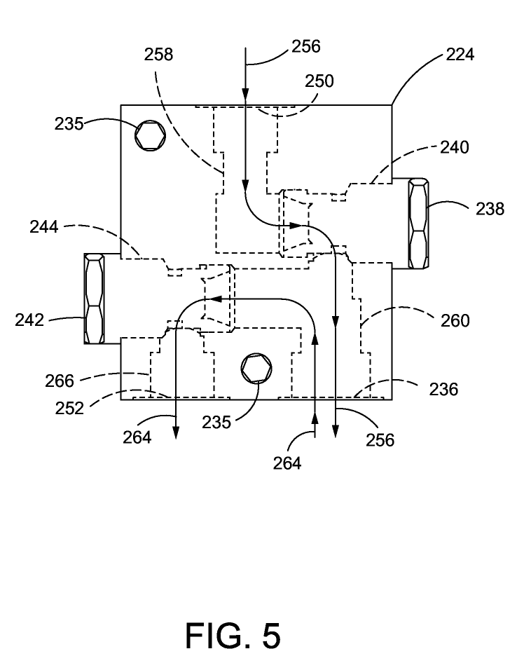

The first and second check valves 226, 228 may be, for example, integral with an interior of the valve manifold 224, may be frictionally fit into the valve manifold 224 or may be screw-in cartridge check valves received by the valve manifold 224, as illustrated. FIG. 5 illustrates, using hidden lines, one possible configuration of conduits and cartridge check valves within the valve manifold 224. For example, the first check valve 226 may be a first screw-in cartridge check valve 238 received in a first cavity 240 of the valve manifold 224. Likewise, the second check valve 228 may be a second screw-in cartridge check valve 242 received in a second cavity 244 of the valve manifold 224. Screw-in cartridge valves are commonly used in hydraulic systems; and the first and second screw-in cartridge check valves 238, 242 of the present disclosure may be any number of screw-in cartridge valves known in the art that include any type of check valves known in the art.

The first cartridge check valve 238 may be in fluid communication with a breather 246, while the second cartridge check valve 242 may be in fluid communication with an exhaust conduit 248. The breather 246 may be received by or otherwise engaged with a second port 250 of the valve manifold 224. Likewise, exhaust conduit 248 may be received by or otherwise engaged with a third port 252 of the valve manifold 224. The exhaust conduit 248 may be a hose, a pipe or any other fluid conduit known in the art. In the disclosed embodiments, the exhaust conduit 248 is fabricated from steel. The engagements of the breather 246 and the exhaust conduit 248 with the ports 250 and 252, respectively, may comprise spouts, a threaded arrangement, a friction fit or any other known attachment means. Fluid exiting the valve manifold 224 through the exhaust conduit 248 may be collected in a container (not shown) disposed downstream of an end 254 of the exhaust conduit 248.

The breather 246 may be any breathing assembly known in the art, including, for example, a screw-in dome type breather received in the second port 250 of the valve manifold 224. The breather 246 may allow for intake of atmospheric air into the valve manifold 224 and ultimately into the hydraulic tank 202 due to pressure changes or a vacuum created within the tank 202. A vacuum may result, for example, from a decrease in the volume of the hydraulic fluid 204 within the tank 202. Breather assemblies for hydraulic tanks, fuel tanks and otherwise, are common in the art and may include, for example, a breather cap, structural components creating fluid passages, bores, venting means, valves, resilient elements, screens, filter elements and attachment mechanisms. Alternatively, the breather 246 may simply be a screen or a filter element that covers or is disposed within the second port 250. Additionally, the second port 250 alone, which facilitates air flow into the valve manifold 224, may function as a breather. Filters or filter material within breathers are common in the art and function to prevent foreign material and pollutants common in the atmosphere of working environments from contaminating liquid within a tank, thereby improving the overall efficiency and durability of the system. The breather 246, being in fluid communication with the first cartridge check valve 238, provides for atmospheric air flow into the valve manifold 224 and the tank 202; however, as described further below, any contaminated air or other fluid to be exhausted from the tank 202 and valve manifold 224 is prevented by the first cartridge check valve 238 from arriving to the breather 246. This configuration provides isolation and protection of the breather 246, as well as any susceptible components therein, from unwanted fluid exposure.

FIG. 5 illustrates, with hidden lines, exemplary inner fluid conduits and screw-in cartridge check valves of the valve manifold 224, as well as fluid flow paths into, within and out of the valve manifold 224. Beginning with an intake fluid flow path 256, in response to a pressure drop within the tank 202, the first screw-in cartridge check valve 238 is opened and atmospheric air is drawn into the valve manifold 224 at the second port 250 through the breather 246, creating the intake fluid flow path 256. After entering the valve manifold 224, air is directed along the intake fluid flow path 256 through a first manifold conduit 258. The first manifold conduit 258 is in fluid communication with the first screw-in cartridge check valve 238. The air is therefore directed along the intake fluid flow path 256 through the opened first cartridge check valve 238 and into a second manifold conduit 260, which is also in fluid communication with the opened first cartridge check valve 238. The air originally drawn into the valve manifold 224 through the breather 246 may then exit the valve manifold 224 at the first port 236 through the fluid conduit 234, ultimately arriving to the tank 202. The first screw-in cartridge check valve 238 allows only a one-way intake fluid flow path 256 from the breather 246, through the first manifold conduit 258 and into the second manifold conduit 260. As such, neither air nor hydraulic fluid is permitted to pass in the reverse direction through the first screw-in cartridge check valve 238 and into the first manifold conduit 258. In this manner, the breather 246 engaged at the second port 250 of the valve manifold 224 is isolated and protected from any exposure to contaminated air or hydraulic fluid that may enter the valve manifold 224 from the tank 202.

Regarding an exhaust fluid flow path 264, in response to increased pressure within the tank 202, air within the tank 202 may be directed out of the tank 202 and into the valve manifold 224. Likewise, due to overfilling of the tank 202 with the hydraulic fluid 204, or filling beyond a target level, the hydraulic fluid 204 may be directed out of the tank 202 and into the valve manifold 224. The exhaust fluid flow path 264, therefore, represents both air and hydraulic fluid flow from the tank 202 into, through and ultimately out of the valve manifold 224. Specifically, air or hydraulic fluid 204 may exit the inlet/outlet port 214 of the hydraulic tank 202 and enter into the fluid conduit 234 attached to the valve manifold 224 at the first port 236. The fluid may then, following the exhaust fluid flow path 264, exit the fluid conduit 234 and be directed through the second manifold conduit 260 of the valve manifold 224. The second manifold conduit 260 is in fluid communication with the second screw-in cartridge check valve 242, which may open under the pressure of the fluid to be exhausted. The fluid is therefore directed along the exhaust fluid flow path 264 through the opened second cartridge check valve 242 and into a third manifold conduit 266, which is also in fluid communication with the opened second cartridge check valve 242. The fluid originally taken into the valve manifold 224 from the fluid conduit 234 may then be directed out of the valve manifold 224 at the third port 252 and through the exhaust conduit 248. The second screw-in cartridge check valve 242 allows only a one-way exhaust fluid flow path 264 from the second manifold conduit 260 and into the third manifold conduit 266. Neither air nor hydraulic fluid is permitted to pass in the reverse direction through the second screw-in cartridge check valve 242 and back into the second manifold conduit 260. In this manner, both contaminated air and hydraulic fluid exhausted and meant to be collected may be prevented from passing back into the hydraulic tank 202.

While the flow paths 256 and 264 are illustrated as passing through various ports and fluid conduits entering and exiting at various sides of the valve manifold 224, it will be appreciated that many different arrangements of ports and fluid conduits may be employed in the disclosed valve manifold 224, so long as two check valves may be engaged. The alternative arrangements may include any fluid flow path allowing for atmospheric air to enter the valve manifold 224 through a breather 246 and ultimately arrive at the tank 202, as well as any flow path allowing for air or hydraulic fluid 204 to enter the valve manifold 224 from the tank 202 and thereafter exit the valve manifold 224, the combination avoiding any risk of the breather 246 being exposed to contaminated air or hydraulic fluid 204 meant to be exhausted from the valve manifold 224. Likewise, additional ports and fluid conduits may be incorporated in the manifold 224 thus providing flow paths in addition to the described flow paths 256 and 264. Any such additional flow paths may also include additional valves, including check valves allowing for one-way fluid flow through the valve manifold 224. The hydraulic system 200 is illustrated as including one valve manifold 224 associated with the hydraulic tank 202; however, it will be appreciated that any number of valve manifolds 224 may be employed in the hydraulic system 200 and may be connected to or mounted to the hydraulic tank 202 at various locations on the tank 202.

While the above detailed description and drawings are made with reference to a hydraulic system and method associated with a mining machine, it is important to note that the teachings of this disclosure can be employed in other systems and methods, for example, internal combustion engines, and may be used in any other applications where machines may be employed, such as in construction, agriculture and industrial environments.

### INDUSTRIAL APPLICABILITY

In operation, the teachings of the present disclosure can find applicability in many industries including, but not limited to, earth-moving equipment, mining machines, marine engines and power-generation machinery. For example, the valve manifold with breather protection of the present disclosure could be used onboard continuous miners, track-type tractors, dozers, excavators, motor graders, articulated trucks, haul trucks, generator sets, marine vessels, etc. Examples of additional underground mining machines that may employ the disclosed valve manifold with breather protection include a feeder breaker, a roof bolter, a utility vehicle for mining, a load haul dump vehicle, a scoop, an underground mining loader, an underground articulated truck or another type of heavy machinery or system used in underground mining. By incorporating the valve manifold of the present disclosure, such machines are provided with a breather that not only allows air flow in and out of the hydraulic system to accommodate volumetric changes in the hydraulic fluid level, but which does so with a lessened likelihood of breather clogging and contamination.

The improved valve manifold 224 and methods disclosed herein, employing two check valves 226, 228, may be used with any fluid tank system known in the art and provide an altogether new strategy for fluid circulation in the system. The improved valve manifold 224 disclosed may be used in connection with hydraulic tanks, fuel tanks, lubrication tanks and cooling tanks, as well as with internal combustion engines. In addition the machine 100 may be a fixed or mobile machine. Through the first check valve 226 of the disclosed valve manifold 224, passage of atmospheric air may be allowed into the valve manifold 224 and ultimately into the tank 202, thereby maintaining a desired pressure within the tank 202. The disclosed valve manifold 224 may also allow, through the second check valve 228, passage of fluid, including air or hydraulic fluid 204, into the valve manifold 224 from the tank 202 for ultimate collection outside of the valve manifold 224. During this fluid intake and exhaust, the breather 246 associated with the valve manifold 224 advantageously remains uncontaminated.

Referring to the drawings generally, during an exemplary operation of the disclosed hydraulic system 200, the pressure within the hydraulic tank 202 may drop or a vacuum may be created therein. For example, as the hydraulic fluid 204 is pumped out of the hydraulic tank 202 for operation of a hydraulically actuated component of the machine 100, the decrease in the volume of hydraulic fluid 204 within the tank 202 may result in a temporary vacuum therein. In response, the first screw-in cartridge check valve 238 of the valve manifold 224 may open, allowing atmospheric air to be drawn in through the breather 246. In addition to passing through multiple passageways of a typical breather assembly, the atmospheric air drawn in may also pass through screens or filter media present in the breather 246, thereby cleansing the air of various debris or pollutants common in work environments. Air flow into the hydraulic system 200 through the valve manifold 224, is illustrated by the intake fluid flow path 256. Specifically, air is directed through the first manifold conduit 258, through the opened first cartridge check valve 238, and through the second manifold conduit 260 before ultimately exiting the valve manifold 224 and being delivered to the hydraulic tank 202 via the fluid conduit 234. Because the first cartridge check valve 238 only allows one-way movement of fluid there through, neither air nor hydraulic fluid 204 present in the valve manifold 224 can pass in the reverse direction through the first cartridge check valve 238. As such, the first manifold conduit 258 of the valve manifold 224 is maintained free of contaminated air and hydraulic fluid from elsewhere in the valve manifold 224 or from the tank 202. In turn, the breather 246 remains unexposed to any such contaminated air and/or hydraulic fluid.

During intake of atmospheric air into the system 200 to satisfy a pressure drop in the tank 202, air is directed through the opened first cartridge check valve 238 while the second cartridge check valve 242 remains closed. The second cartridge check valve 242 is instead opened when exhausting air or hydraulic fluid 204 from the system 200. For example, pressure build-up in the hydraulic tank 202 may occur when the hydraulic fluid 204 volume increases within the tank 202 due to return of the hydraulic fluid 204 to the tank 202 from the actuator 106 or otherwise. In turn, air within the tank 202 may be directed out of the tank 202 and into the valve manifold 224 along the exhaust fluid flow path 264. Specifically, air may be carried to the valve manifold 224 through fluid conduit 234. Once received in the valve manifold 224, the air to be exhausted from the system may pass through the second manifold conduit 260, through the opened second cartridge check valve 242, through the third manifold conduit 266 before ultimately exiting the valve manifold 224 through the exhaust conduit 248. Therefore, the second cartridge check valve 242 is opened during flow of air out of the system 200. Because the second cartridge check valve 242 only allows one-way movement of fluid there through, air cannot reenter the valve manifold 224 by passing in the reverse direction through the second cartridge check valve 242.

In addition to the exhaust of air through the valve manifold 224, operation of the hydraulic system 200 may also require the exhaust of the hydraulic fluid 204. For example, with use and time, or due to leakage of the fluid 204 from the hydraulic tank 202, a level of the fluid 204 may decrease within the tank 202, thereby requiring refilling or replenishment to a desired fluid volume. The first fluid inlet 206 on the tank 202 may receive the hydraulic fluid 204 for filling the tank 202 from a mobile or immobile hydraulic fluid source 216. Occasionally, excess fluid 204 may be pumped into the tank 202 resulting in overfilling of the tank 202 and expulsion of the excess fluid 204 through the inlet/outlet port 214 and into the fluid conduit 234. Like air being exhausted from the tank 202, the hydraulic fluid 204 may follow the same exhaust fluid flow path 264 illustrated in FIG. 5. Specifically, the hydraulic fluid 204 may enter the valve manifold 224 through fluid conduit 234. Once received in the valve manifold 224, the fluid 204 to be exhausted from the system 200 may pass through the second manifold conduit 260, through the opened second cartridge check valve 242, and through the third manifold conduit 266 before ultimately exiting the valve manifold 224 through the exhaust conduit 248. Excess fluid 204 directed out of the valve manifold 224 may then be collected in a container (not shown) downstream of the end 254 of the exhaust conduit 248. Therefore, the second cartridge check valve 242 is opened during flow of hydraulic fluid 204, as well as air, out of the system 200. Because the second cartridge check valve 242 only allows one-way movement of fluid there through, the hydraulic fluid 204 cannot reenter the valve manifold 224 by passing in the reverse direction through the second cartridge check valve 242.

Therefore, during operation of the hydraulic system 200, the first cartridge check valve 238 opens to allow atmospheric air into the system 200 while the second cartridge check valve 242 remains closed. Likewise, during filling of the tank 202 or otherwise, the second cartridge check valve 242 opens to allow fluid flow out of the system 200, both air and hydraulic fluid flow, while the first cartridge check valve 238 remains closed. As described above, this configuration avoids exposure of the breather 246 to air or hydraulic fluid 204 in the valve manifold 224. Specifically, during filling or overfilling of the tank 202, any contaminated air or hydraulic fluid 204 directed under pressure into the valve manifold 224 is prevented, by the one-way first cartridge check valve 238, from reaching the first manifold conduit 258 or the breather 246. The breather 246 is therefore isolated and protected in the presently disclosed valve manifold 224. As exposure of the filter elements and other components of the breather 246 to fluid flowing from the tank 202 is known to adversely affect the breather 246, the protection of the breather 246 by the presently disclosed valve manifold 224 having two check valves may increase the durability, efficiency and lifetime of the breather 246. Accordingly, the efficiency of the hydraulic system 200 as a whole is improved. In addition, the disclosed valve manifold 224 and methods may reduce the undesirable hydraulic fluid spills that commonly occur when the hydraulic tank 202 is overfilled. Specifically, because the first cartridge check valve 238 is closed to fluid 204 exiting the system 200, the fluid (air or hydraulic fluid) can only be directed through the second cartridge check valve 242 and out of the valve manifold 224, and thereafter collected in a container downstream. Therefore, rather than having the hydraulic fluid 204 forced through the breather 246, possibly ruining the breather 246 and spilling onto the valve manifold 224 or the machine 100 itself, the excess fluid may be collected. In this manner, the improved valve manifold 224 and method of circulating fluid into and out of the system 200 avoids contamination of the machine and the environment, as well as the environmental hazards that accompany fluid spills.

All references to the disclosure or examples thereof are intended to reference the particular example being discussed at that point and are not intended to imply any limitation as to the scope of the disclosure more generally. Additionally, those skilled in the art will appreciate that various modifications might be made to the presently disclosed embodiments without departing from the full and fair scope of the present disclosure.

What is claimed is:

1. A valve manifold for a fluid tank, comprising:
a breather configured to receive atmospheric air;
a first check valve in fluid communication with the breather and configured to allow fluid intake into the valve manifold; and
a second check valve configured to allow fluid exhaust out of the valve manifold.

2. The valve manifold of claim 1, wherein the first check valve is a screw-in cartridge check valve, and the second check valve is a screw-in cartridge check valve.

3. The valve manifold of claim 1, wherein the breather is a screw-in dome breather.

4. The valve manifold of claim 1, wherein the breather includes a filter element.

5. The valve manifold of claim 1, further comprising:
a first port configured to engage with a fluid conduit;
a second port configured to engage with the breather; and
a third port configured to engage with an exhaust conduit.

6. The valve manifold of claim 1, further comprising a first manifold conduit, a second manifold conduit and a third manifold conduit.

7. The valve manifold of claim 6, wherein the first check valve provides fluid communication between the first manifold conduit and the second manifold conduit, and wherein the second check valve provides fluid communication between the second manifold conduit and the third manifold conduit.

8. The valve manifold of claim 6, wherein the first manifold conduit, the first check valve and the second manifold conduit define an intake fluid flow path, and wherein the second manifold conduit, the second check valve and the third manifold conduit define an exhaust fluid flow path.

9. The valve manifold of claim 6, wherein the first check valve is configured to prevent fluid communication from the second manifold conduit to the breather.

10. A hydraulic system, comprising:
a hydraulic fluid tank;
an actuator in fluid communication with the tank and configured to receive pressurized hydraulic fluid from the tank; and
a valve manifold in fluid communication with the tank, the valve manifold comprising a breather in fluid communication with a first check valve, the first check valve configured to allow fluid intake into the hydraulic system, and a second check valve, the second check valve configured to allow fluid exhaust out of the hydraulic system.

11. The hydraulic system of claim 10, wherein the first check valve is a screw-in cartridge check valve, and the second check valve is a screw-in cartridge check valve.

12. The hydraulic system of claim 10, wherein the valve manifold is mounted on the tank.

13. The hydraulic system of claim 10, further comprising a fluid conduit configured to provide fluid communication between the valve manifold and the tank.

14. The hydraulic system of claim 13, further comprising an intake fluid flow path between the breather, the first check valve, the fluid conduit and the tank, and an exhaust fluid flow path between the tank, the fluid conduit and the second check valve.

15. The hydraulic system of claim 10, wherein the first check valve is configured to prevent fluid communication from the tank to the breather.

16. The hydraulic system of claim 10, further comprising an exhaust conduit in fluid communication with the second check valve.

17. The hydraulic system of claim 10, further comprising a container configured to collect fluid exhausted from the tank.

18. A method of circulating fluid in a hydraulic system, comprising:
providing a hydraulic fluid tank;
providing a valve manifold in fluid communication with the tank, the valve manifold including a breather;
intaking fluid into the hydraulic system by passage of the intake fluid from the breather, through a first check valve in the valve manifold and into the tank; and
exhausting fluid from the hydraulic system by passage of the exhaust fluid from the tank, through a second check valve in the valve manifold and out of the valve manifold.

19. The method of claim 18, wherein the second check valve remains closed during the intake of fluid into the hydraulic system, and wherein the first check valve remains closed during the exhaust of fluid out of the hydraulic system.

20. The method of claim 18, wherein the breather remains isolated from all fluid exhausted from the hydraulic system.
